(19) United States
(12) Patent Application Publication
(10) Pub. No.: US 2004/0234711 A1
(43) Pub. Date: Nov. 25, 2004

(54) Controlled release surface treatment article

(76) Inventor: Allen Young, Phoenix, AZ (US)

Correspondence Address: WEISS & MOY PC, 4204 NORTH BROWN AVENUE, SCOTTSDALE, AZ, 85251, US

(21) Appl. No.: 10/444,354

(22) Filed: May 23, 2003

(51) Int. Cl. F16L 1/00

(52) U.S. Cl. 428/34.1

(57) ABSTRACT

A surface treatment article is provided that includes wet layer(s) of at least one lower substrate layer and at least one flexible container containing a product and having at least one rupturable barrier adapted to burst under an application of pressure to allow at least a portion of said product to be expelled from the at least one flexible container onto a target surface. The surface treatment article may also include at least one substantially moisture impermeable layer over the wet layer(s) to act as a barrier between the user and the wet layers (product). The bottom surface of the at least one lower substrate layer may be covered by an apertured thermoplastic film to substantially ensure one-way flow of the product and stain removed from the target surface.

### FIELD OF THE INVENTION

This invention relates generally to surface treatment articles and more particularly to a controlled release surface treatment article and method.

### BACKGROUND OF THE INVENTION

Various types of surface treatment articles are known in the art. For example, conventional surface treatment articles include cloth or paper towels, mops, brooms or the like to which a chemical agent from a product container may be applied. Carpet cleaning has conventionally required heavy machinery with heavy tanks containing the cleaning agent. These conventional surface treatment articles have many disadvantages. They are inconvenient and time-consuming to use. They may require washing between uses and can cross-contaminate surfaces. Over time, they become permanently soiled and malodorous. In the case of paper towels, they are additionally expensive, weak, and with limited absorbency.

Pre-moistened disposable towelettes or wipes were developed out of a need for convenience and are now used in many applications to replace conventional articles. A typical pre-moistened wipe is a sheet of non-woven material saturated with an aqueous solution of a cleaning or other chemical agent. Preservations and fragrances may also be added. The wipes are typically saturated with the chemical agent by capillary action and gravity. The pre-moistened wipes may be packaged as a stack in an outer container such as a tub or softpack or as a log in a canister. The wipes are removed from the outer container and the user may easily and conveniently hand wipe over a target surface.

A prevailing problem with pre-moistened wipes is that the wipes dry out over time and become useless for their intended purpose. Users typically discover their dry condition just when they need them. Moreover, the very nature of wipes forces the user into physical contact with the chemical agent which may cause an allergic or other undesirable reaction.

There are also problems associated with manufacturing and packaging of the premoistened wipes. Their production is relatively expensive. The large surface area and layering of the wipes along with the closed, dark, and humid environment within the outer container makes the pre-moistened wipes enclosed therein particularly susceptible to contaminants. Excessive amounts of preservatives must then be added to the wipes to substantially prevent such contamination. Such environment also limits the type of chemical agents that may be added to the non-woven material. For example, flammable materials typically cannot be added to wipes because of the danger of fire during their storage. In addition, prolonged exposure to the chemical agents during storage may cause package degradation.

Due to such material and manufacturing limitations, loading the non-woven material with the cleaning or other chemical agent is also problematic. The stacking and logging of the wipes within the outer container causes uneven saturation of the cleaning or other chemical agent throughout the entire stack or log of pre-moistened wipes, with the heaviest concentration of the cleaning or other chemical agent being toward the bottom of the stack or the bottom of the log. Similarly, viscous agents are typically not added to wipes because they do not saturate throughout the wipes, instead just sitting on the top layer of the stack or log. Increased mold development may occur without thorough saturation.

Accordingly, there has been a need for a novel surface treatment article and method that permit a controlled release of a flowable product into a substrate layer (the wipe) when desired thereby substantially eliminating the drying out problem. There is also a need for a novel surface treatment article and method that are shelf stable. There is another need for a novel surface treatment article and method that may be used in any type of surface treatment. There is still another need for a novel surface treatment article and method that require a substantially lower level of preservative than used with conventional pre-moistened wipes. There is a still further need for a novel surface treatment article and method that are convenient, ready and easy to use when desired. There is an additional need for a novel surface treatment article and method that permit the addition of flowable products including, but not limited to, those with higher viscosity and with lower flash points. There is a still further need for a novel surface treatment article and method that may permit use thereof without substantial contact with the flowable product by the user There is an additional need for a novel surface treatment article and method that bypass conventional material and manufacturing limitations. The present invention fulfills these needs and provides other related advantages.

### SUMMARY OF THE INVENTION

According to the present invention and exemplary embodiments thereof described herein, a surface treatment article is provided for use in treating target surfaces. The surface treatment article comprises, generally, at least one substrate layer and at least one flexible container containing a product and having at least one rupturable barrier adapted to burst under an application of pressure to allow at least a portion of said product to be expelled from the at least one flexible container for use with the at least one substrate layer for treating a target surface. The surface treatment article may also include at least one substantially moisture impermeable layer to act as a barrier between the user and the product. The at least one substrate layer includes a top surface and a bottom surface. The at least one substrate layer may be comprised of a material that may be a woven fabric, knit fabric, nonwoven fabric, foam, or paper material to which additives may have been added. Additional substrate materials which can be used include foams and films that are fibrillated, apertured or otherwise treated to have fiber-like properties as well as laminates of these and/or nonwoven webs.

The top surface of the at least one substrate layer may include a slot. The bottom surface of the at least one substrate layer may be fully or partially covered by at least one layer of an apertured thermoplastic film. The at least one substrate layer and the at least one layer of the apertured thermoplastic film are referred to herein as the “wet layers” because of their intended contact with the product. They are also referred to herein as the “lower layers” of the surface treatment article. As used herein, the lower layer means layer(s) that are relatively closer to the target surface. Conversely, the upper layer means layer(s) that are relatively farther from the target surface.

The at least one substantially moisture impermeable layer separates the wet lower layers and the dry upper layers of the surface treatment article. The at least one substantially moisture impermeable layer is either immediately over the flexible container or separated from the flexible container by intervening layer(s) of substrate material. The at least one moisture impermeable layer substantially prevents the expelled product from wetting the upper layers thereby substantially maintaining a dry contact surface for the user. The at least one substantially moisture impermeable layer may comprise a film such as plastic. The dry upper layers may also take the form of a pocket or mitt for insertion of a hand.

The surface treatment article may also include a useful layer that may be used to perform a function related to the product in the flexible container. The useful layer may be the exterior upper layer over or on the at least one moisture impermeable layer. The useful layer may be used for polishing, buffing, drying, or other finishing functions. The upper and lower layers may be separate layers attached by conventional means or part of a co-extruded or laminated structure.

The at least one flexible container may be positioned on or above the wet layer(s) or between the wet layers. The at least one flexible container may comprise a pouch. The pouch may be formed from a flexible impermeable film or other material having a low moisture vapor transmission rate. If between layers, the pouch may be secured in the surface treatment article when the layers are joined. The pouch may also be affixed to an underlying layer such as by adhesive or the like. The pouch may additionally be mounted to the top surface of the at least one substrate layer by insertion of a pouch tab into the slot therein. The pouch may cover all or a portion of the top surface of the at least one substrate layer or the apertured thermoplastic film layer. The pouch has a permanent and strong seal extending about at least a portion of the periphery of the pouch. The pouch also includes at least one rupturable barrier with a lower threshold for failure than the permanent and strong seal. The product may be dispensed by applying pressure to the flexible container to burst the rupturable barrier and expel at least a portion of the product out of the flexible container. The rupturable barrier may be a portion of the bottom surface of a pouch or in the tab if present. The rupturable barrier may be weakened portions in the flexible pouch itself. The rupturable barrier may also include frangible seals, zippers, heat seams, tear strips, scores, perforations and the like. The rupturable barrier may also be a portion of the flexible pouch that is punctured by a puncture device.

The rupturable barrier may be in product communication with at least one exit channel. The at least one exit channel may be vertically aligned with the rupturable barrier and the puncture device. The at least one exit channel extends downwardly from the flexible pouch through at least a portion of the substrate layer(s) and/or apertured thermoplastic film layer(s) toward the target surface. In a first embodiment, the at least one exit channel may be formed, for example, by die-cutting a vertical channel through the at least one substrate layer(s) and/or apertured thermoplastic film layer(s). In a second embodiment, the at least one exit channel comprises a tube. The at least one exit channel substantially directs the flow of product from the burst rupturable barrier to the target surface bypassing the at least one substrate layer and/or the at least one apertured thermoplastic film layer. A surface treatment article without the at least one exit channel may also be used.

The at least one exit channel and rupturable barrier may be vertically aligned with the puncture device. The puncture device may comprise a disk with a sharpened point in substantially the center of the disc and a plurality of bosses along the circumference of the disk. A bottom surface of the disk may be affixed to the inside top surface of the pouch in a manner such that the sharpened point of the puncture device points downwardly toward the rupturable barrier in the bottom surface of the pouch. In another embodiment, the puncture device comprises an extension of a free end of the at least one exit channel, the extension including a flexible arm with the sharpened point. In another embodiment, the puncture device comprises a disk with a sharpened point in substantially the center of the disk and at least one opening in the disk. The disk is friction fit into the at least one exit channel such that the sharpened point points upwardly toward the rupturable barrier in the bottom surface of the pouch. In still another embodiment, the puncture device comprises a disk with a sharpened point in substantially the center of the disk and a plurality of bosses that snap fit over a lower portion of the at least one exit channel and the protruding pouch.

When pressure is applied to the top surface of the pouch, the sharpened point of the puncture devices is driven toward the rupturable barrier in the bottom surface of the pouch thereby bursting the barrier and causing at least a portion of the product to be expelled from the pouch. The product flows into the exit channel through the space created by the bosses or through the at least one opening in the disk. The product is then directed to the target surface down the at least one exit channel.

In another embodiment, the pouch may include a primary chamber containing the product that is separated from at least one secondary chamber by a rupturable barrier. It is to be appreciated that any number of secondary chambers may be used. The secondary chamber(s) may be initially empty. The secondary chambers may include at least one opening therein through which product is expelled when the rupturable barrier between the primary chamber and the respective secondary chamber is ruptured thus permitting the flow of product from the primary chamber of the flexible pouch into the secondary chamber(s) and then out of the secondary chamber(s) through an opening therein and onto the target surface. The opening may be in product communication with the at least one exit channel. The products in the at least one flexible container include any flowable product.

In the method of the invention, the surface treatment article is placed onto the target surface. The user applies pressure to the surface treatment article thereby breaking the rupturable barrier of the flexible container to dispel at least a portion of the product therefrom into the at least one substrate layer or through at least one exit channel directly onto the target surface. The used surface treatment article may then be discarded.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a perspective view of a surface treatment article embodying one embodiment of the present invention, illustrating a surface treatment article having a substrate layer contacting a target surface and a flexible pouch containing at least one product mounted on a top surface of the substrate layer;

FIG. 1A is a sectional view of the surface treatment article shown in FIG. 1, illustrating the flexible pouch on the top surface of the substrate layer, with an exit channel leading downwardly from the flexible pouch through the substrate layer;

FIG. 1B is another sectional view of the surface treatment article similar to FIG. 1A without the exit channel;

FIG. 1C is an enlarged view of a rupturable barrier in a bottom surface of the flexible pouch shown in FIG. 1, illustrating by cross hairs the weakened portion of the pouch;

FIG. 1D is an enlarged view of an alternative rupturable barrier similar to FIG. 1C, illustrating a patch for the bottom surface of the flexible pouch, the patch material having a lower failure threshold than the flexible pouch material;

FIG. 2 is a perspective view of another surface treatment article;

FIG. 2A is a fragmented sectional view of the surface treatment article of FIG. 2, illustrating a top useful layer separated from the flexible pouch and a substrate layer by a layer of substantially moisture impermeable film with the exit channel passing downwardly through the substrate layer;

FIG. 3 is a fragmented horizontal sectional view of another surface treatment article having a bottom layer of an apertured thermoplastic film, a middle layer of substrate material, and a top layer of substantially moisture impermeable film with the flexible pouch mounted between the apertured thermoplastic film layer and the substrate material layer and the exit channel passing downwardly through the apertured thermoplastic film layer;

FIG. 3A is an exploded view of the surface treatment article of FIG. 3, illustrating the bottom layer of the apertured thermoplastic film on which the flexible pouch is mounted, the middle layer of substrate material, and the top layer of substantially moisture impermeable material;

FIG. 4 is a fragmented side view of another surface treatment article, illustrating the flexible pouch mounted on a top surface of the substrate layer with a puncture device mounted to the inboard top surface of the flexible pouch above the rupturable barrier in the bottom surface of the pouch and vertically aligned with the exit channel through the substrate layer;

FIG. 4A is a top view of the puncture device of FIG. 4, illustrating a disc having a plurality of opposed bosses and a sharpened point in substantially the center of the disc with the flow of product around the disk;

FIG. 5 is a fragmented side view of the surface treatment article of FIG. 4 with an alternative puncture device extending from a free end of the exit channel;

FIG. 6 is a fragmented side view of the surface treatment article of FIG. 4, illustrating another puncture device friction fit into the exit channel;

FIG. 6A is a top view of the puncture device of FIG. 6, illustrating the disc having at least one opening for flow of the product into the exit channel and the sharpened point in substantially the center of the disc;

FIG. 6B is an fragmented side view of the puncture device of FIG. 6, illustrating the sharpened point bursting the rupturable barrier of the flexible pouch when pressure is applied to the top surface of the flexible pouch;

FIG. 7 is a fragmented side view of the flexible pouch mounted on the top surface of the substrate layer with the exit channel inside the pouch, illustrating another puncture device that snap fits around the exit channel when moved upward upon the application of pressure to the top surface of the pouch;

FIG. 7A is an fragmented side view of the puncture device of FIG. 7 bursting the rupturable barrier;

FIG. 8 is a perspective view of another embodiment of the surface treatment article, illustrating a bottom substrate layer with a pair of upper layers of impermeable film joined to define a mitt on the bottom substrate layer;

FIG. 9 is a horizontal sectional view taken generally on the line 9-9 of FIG. 8, illustrating the flexible pouch between the bottom substrate layer and the mitt;

FIG. 10 is a horizontal sectional view of another surface treatment article, illustrating a bottom pre-moistened substrate layer under a top layer of a substantially moisture impermeable film, the pre-moistened substrate layer exposed by removal of a film cover;

FIG. 11 is a horizontal sectional view of another surface treatment article, including a top layer of moisture impermeable material, a pair of intermediate substrate layers, and a bottom layer of an apertured thermoplastic film, illustrating the flexible pouch and the exit channel leading therefrom downwardly through one of the substrate layers and the bottom layer of the apertured thermoplastic film;

FIG. 12 is a side view of another surface treatment article, illustrating a flexible pouch mounted to the top surface of a rupture disc at a top end of the exit channel, illustrating a bottom layer of an apertured thermoplastic film and a top layer of substrate material over which the rupture disc and flexible pouch are mounted and through which the exit channel passes;

FIG. 13 is a perspective assembly view of another surface treatment article, showing a substrate layer having a slot in the top surface thereof for receiving a tab of a pouch containing product;

FIG. 13A is a fragmented top view of the slot in the top surface of the surface treatment article of FIG. 13;

FIG. 14 is a perspective view of the surface treatment article of FIG. 13, showing the expelling of at least a portion of the product contained in the flexible pouch onto the bottom surface of the substrate layer;

FIG. 15 is a horizontal sectional view taken along the line 15-15 of FIG. 14;

FIG. 16 is a vertical sectional view of the flexible pouch of FIGS. 13-15;

FIG. 17 is an enlarged vertical sectional view of the rupturable barrier of the flexible pouch of FIG. 16;

FIG. 18 is a bottom view of a flexible pouch, illustrating a rupturable barrier including thicker and thinner regions;

FIG. 18A is a detailed view of the rupturable barrier of FIG. 18;

FIG. 19 is a horizontal sectional view of the flexible pouch taken generally along the line 19-19 of FIG. 18;

FIG. 20 is a vertical sectional view of another flexible pouch, illustrating the primary chamber connected to a secondary chamber by a rupturable barrier;

FIG. 21 is a vertical sectional view of a flexible pouch similar to FIG. 20, illustrating the primary chamber connected to multiple secondary chambers by rupturable barriers;

FIG. 22 is a perspective view of the flexible pouch of FIG. 20, illustrating product flow out of an opening in the secondary chamber after breakage of the rupturable barrier;

FIG. 23 is a top view of the flexible pouch of FIG. 21; and

FIG. 24 is a horizontal sectional view of the flexible pouch of FIG. 22, illustrating the direction of product flow from the primary chamber into the secondary chamber and out through an exit channel in communication with the opening in the secondary chamber.

### DETAILED DESCRIPTION OF THE PREFERRED EMBODIMENTS

As shown in the drawings for purposes of illustration, the present invention is concerned with a controlled release surface treatment article, generally designated in the accompany drawings by the reference number 10. The method for delivering a product to a target surface is also provided. The surface treatment article 10 comprises, generally, at least one substrate layer 12 and at least one flexible container 14 containing a product (not shown) and having at least one rupturable barrier 16 adapted to burst under an application of pressure to allow at least a portion of said product (not shown) to be expelled from the at least one flexible container 14 for use with the at least one substrate layer 12 for treating a target surface 18. The surface treatment article 10 may also include at least one substantially moisture impermeable layer 20 to act as a barrier between the user and the product.

In accordance with the present invention, and as illustrated with respect to preferred embodiments in FIGS. 1-24, the surface treatment article 10 substantially eliminates the evaporation problem commonly associated with conventional wipes by controlling release of the product until the article is to be used. It also substantially eliminates the manufacturing and material limitations associated with conventional wipes. It is also substantially more effective at delivering product directly to the target surface 18 resulting in better stain treatment and disinfection.

The at least one substrate layer 12 may be in the form of a pad, sheet, block or the like depending upon the intended use of the surface treatment article 10. The at least one substrate layer 12 may transfer or absorb product depending on the substrate material used and its intended application. The at least one substrate layer 12 includes a top surface 22 and a bottom surface 24. The at least one substrate layer 12 may be comprised of a material that can be a woven fabric, knit fabric, nonwoven fabric, foam, or paper material to which additives may have been added. The at least one substrate layer 12 may also be impregnated or the like with a chemical agent. Advantageously the substrate material is a nonwoven web and may be, for example, meltblown, spunbond, coformed or a bonded carded web or made by other known web processes. Additional substrate materials which can be used include foams and films that are fibrillated, apertured or otherwise treated to have fiber-like properties as well as laminates of these and/or nonwoven webs. As used herein the term “nonwoven fabric or web” means a web having a structure of individual fibers or threads, which are interlaid, but not in a regular or identifiable manner as in a knitted fabric. The term also includes individual filaments and strands, yarns or tows as well as foams and films that have been fibrillated, apertured, or otherwise treated to impart fabric-like properties. Additionally, materials comprised of a plurality of nylon fibers bonded together such as in a Scotchbrite® pad may be used in the at least one substrate layer 12. The at least one substrate layer 12 should be durable, lofty, printable, and permeable or semipermeable.

The preferred weight of exemplary substrate layers are shown below in Table 1:

| Substrate Layer | Gsm Range | | Gsm (Preferred) | |
|---|---|---|---|---|
| Web laying process (WP): | | | | |
| Melt Blown | 20 to 80 | gsm | 45 | gsm |
| Air Laid | 40 to 350 | gsm | 125 | gsm |
| Wet Laid | 40 to 125 | gsm | 55 | gsm |
| Web finishing process (WF): | | | | |
| Hydroentangled or Spunlace | 25 to 125 | gsm | 40 to 65 | gsm |
| Needlepunch | 25 to 350 | gsm | 100 to 225 | gsm |
| Chemical Bonded | 25 to 125 | gsm | 55 | gsm |
| Thermobonded | 26 to 125 | gsm | 55 | gsm |
| Spunbond | 25 to 125 | gsm | 55 | gsm |
| SMS (Spunbond/Melt/Spunbond) | 25 to 125 | gsm | 40 to 65 | gsm |
| Laminated | 26 to 125 | gsm | 55 | gsm |
| Vicotex | 27 to 125 | gsm | 55 | gsm |
| Dual Textured | 28 to 125 | gsm | 55 | gsm |
| Soap Impregnated Needlepunch | 25 to 350 | gsm | 55 to 225 | gsm |
| Print bond | 25 to 125 | gsm | 55 | gsm |

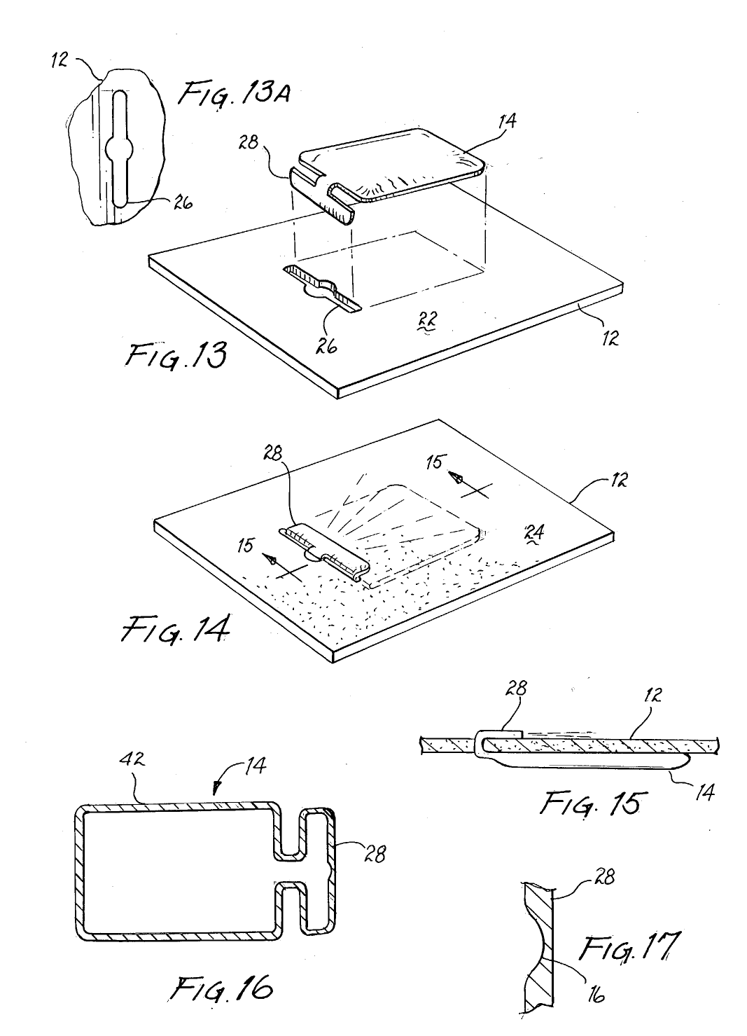

The top surface 22 of the at least one substrate layer 12 may include a slot 26 as shown in FIGS. 13 and 13A. The slot 26 may be die cut or made by some other known means for receiving a tab 28 of the at least one flexible container 14 as hereinafter described.

As shown in FIGS. 3 and 11, the bottom surface 24 of the at least one substrate layer 12 may be fully or partially covered by at least one layer of an apertured thermoplastic film 30 such as described in U.S. Pat. No. 3,929,135 to Thompson, U.S. Pat. No. 4,324,426 to Mullane and Smith, etc. The apertured thermoplastic film is available from, for example, Tredeger Film Products, Richmond, Va. When used, the apertured thermoplastic film 30 contacts the target surface 18. The at least one substrate layer 12 and the at least one layer of the apertured thermoplastic film 30 are referred to herein as the “wet layers” because of their intended contact with the product. They are also referred to herein as the “lower layers” of the surface treatment article. As used herein, the lower layer means layer(s) that are relatively closer to the target surface 18. Conversely, the upper layer means layer(s) that are relatively farther from the target surface 18. The purpose of the apertured thermoplastic film 30 is to allow one-way flow (absorption) of the product and stain into the at least one substrate layer 12 after substantially direct application of the product into a stain through at least one exit channel 32 as hereinafter described. The apertured thermoplastic film 30 substantially prevents the dirt or stain from being reapplied.

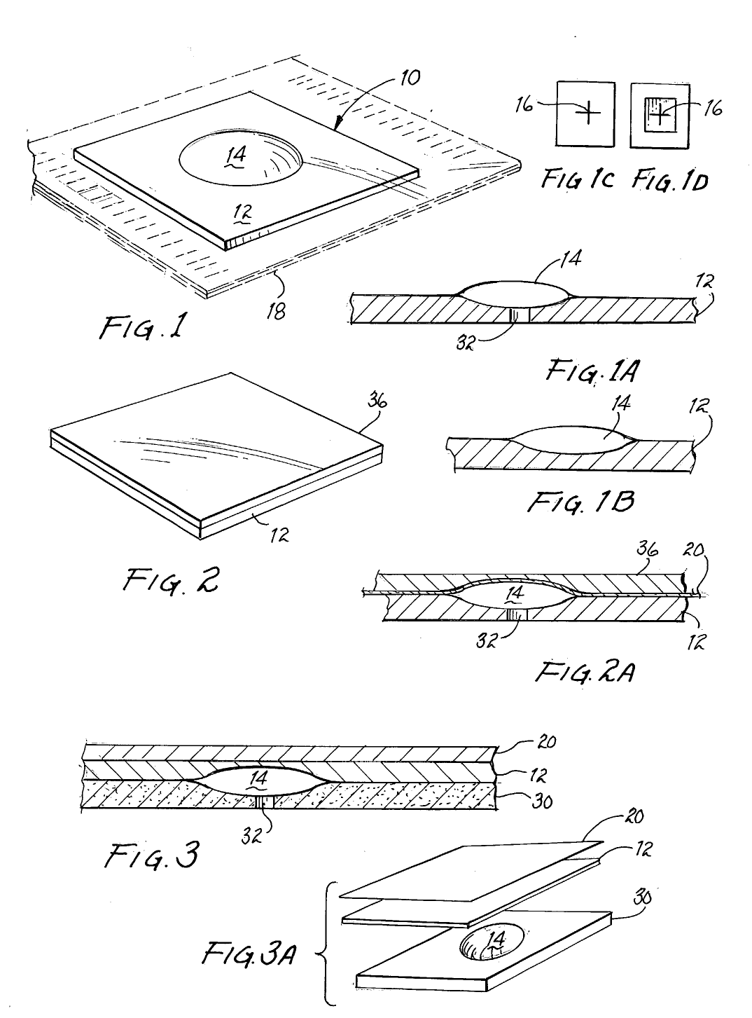

The at least one substantially moisture impermeable layer 20 separates the wet lower layers and the dry upper layers of the surface treatment article. The at least one substantially moisture impermeable layer 20 is over the flexible container 14, either immediately over as shown in FIG. 2A or separated from the flexible container 14 by intervening layer(s) of substrate material as shown in FIG. 3A. The at least one moisture impermeable layer 20 substantially prevents the expelled product from wetting the upper layers thereby substantially maintaining a dry contact surface for the user. The at least one substantially moisture impermeable layer 20 may comprise a film such as plastic. Films may be a single material or a combination of materials that are co-extruded and/or laminated together. The preferred thickness range for a plastic film is about 0.01 mm to about 0.10 mm, preferably about 0.05 mm. The film may also be applied by other conventional means such as spraying, coating, dipping and the like. The means of film application will depend on the particular end use. The film barrier ensures package integrity over time and provides a dry barrier substantially preventing the user from contacting the product. The dry upper layers may also be joined in a known manner to take the form of a pocket or mitt 34 for insertion of a hand as shown in FIGS. 8 and 9.

As shown in FIGS. 2 and 2A, the surface treatment article 10 may also include a useful layer 36 that may be used to perform a function related to the product contained in the flexible container 14. The useful layer 36 may be the exterior upper layer over the at least one moisture impermeable layer 20. The dry useful layer 36 may be made of the same material as the at least one substrate material or from any other material. The useful layer 36 is used for polishing, buffing, drying, or other finishing functions. For example, the useful layer 36 may include an absorbent material that may aid in removing a product from a target surface 18 to which the product has been applied. A flexible container 14 containing a car wax product, for example, may include a buffing pad as the useful layer 36 to aid in buffing an automobile after applying a wax product to the automobile. A surface treatment article 10 including a flexible container 14 containing a skin lotion may also include an abrasive surface that may be used to exfoliate the user's skin before or after the lotion is applied. It is to be understood that any variety of useful layers may be used.

Each of the layers described above may be separate layers attached by conventional means or part of a co-extruded or laminated structure.

The at least one flexible container 14 may be positioned on or above the wet layer(s) or between the wet layers as shown in FIG. 3. The at least one flexible container 14 may comprise a pouch as shown. It is to be understood that the at least one flexible container 14 may also comprise a flexible bottle, a flexible tube, a flexible tub, or the like. The pouch 14 may be any shape. The pouch may be formed from a flexible impermeable film or other material having a low moisture vapor transmission rate (MVTR) in order to minimize losses of the product contained within the pouch 14 or entry of liquid or moisture into the pouch 14 that may contaminate the product contained within the pouch 14 prior to activation of the surface treatment article. The film should also exhibit chemical resistancy to the contained product. The pouch can be of single or multilayered construction. A preferred pouch is comprised of a film with an overall thickness of about 65 microns. The film consists of four layers of about 40 microns thick polyethylene, about 12 microns thick polyester, about 8 microns thick aluminum, and about 5 microns thick adhesive. The temperature to weld these layers together is about 225 to about 250 degrees Centigrade. Another suitable material for the flexible container 14 includes semipermeable reverse osmosis materials such as GORETEX® or the like because of their controlled porosity. It is to be understood that other conventional pouch materials known in the art may also be used within the confines of the invention. The pouch includes a top surface 38 and a bottom surface 40. The bottom surface 40 of the pouch may be mounted to the top surface 22 of the at least one substrate layer 12 or the at least one apertured thermoplastic film layer 30 by any known manner, for example, by adhesive or the like. The pouch 14 may additionally be mounted to the top surface 22 of the at least one substrate layer 12 by insertion of the pouch tab 28 into the slot 26 therein as shown in FIGS. 13 and 13A. The pouch 14 may cover all or a portion of the top surface of the at least one substrate layer 12. It is to be understood that the pouch may not be mounted but simply contained within the surface treatment article when its various layers are joined.

The pouch 14 has a substantially permanent and strong seal 42 extending about at least a portion of the periphery of the pouch (e.g. the pouch may include two or more pieces of film sealed around four sides, may include a film folded over itself and sealed around three sides, etc.). The substantially permanent and strong seal may extend inboard of the periphery of the pouch to define at least one primary chamber and at least one secondary chamber as shown in FIGS. 20-24 and as hereinafter described. The flexible container 14 may be formed and/or sealed in any manner known in the art. For example, a pouch formed out of a polymeric film may be sealed via one or more of the following: heat sealing (e.g. at a temperature of about 180 degrees Fahrenheit), ultrasonic bonding, radio frequency bonding, adhesive bonding, etc.

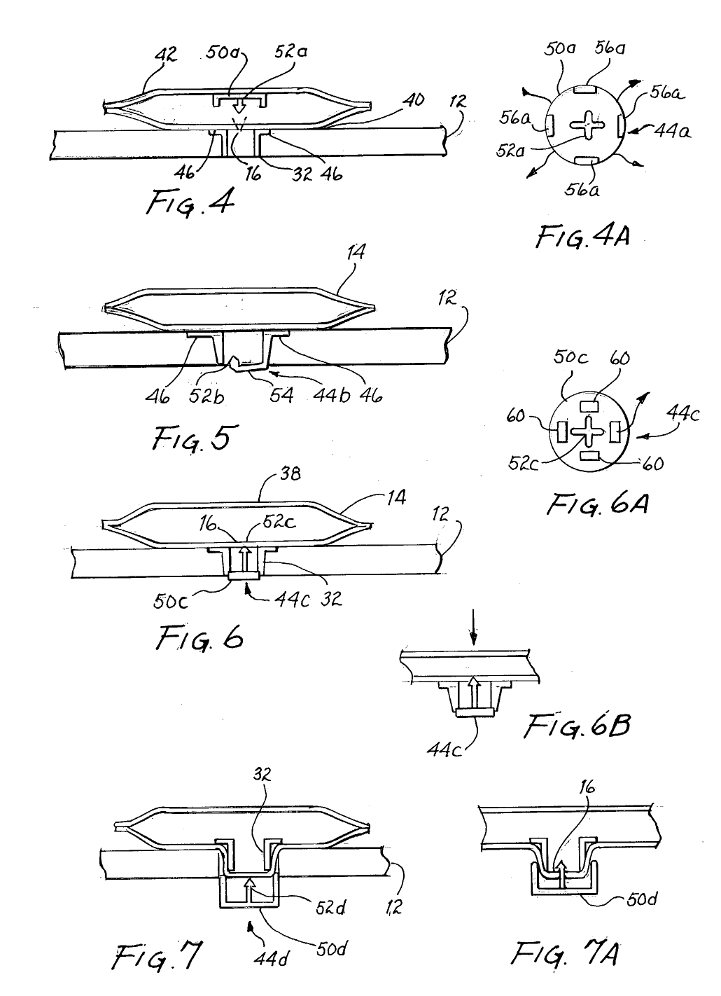

The pouch 14 also includes at least one rupturable barrier 16 with a lower threshold for failure than the permanent and strong seal 42. The product may be dispensed by applying pressure to the flexible container 14, such as by kneading, squeezing, pressing, stepping on, etc. to burst the rupturable barrier 16 and expel at least a portion of the product out of the flexible container 14. As shown in FIGS. 4-7, the rupturable barrier 16 may be a portion of the bottom surface 40 of a pouch or in the tab 28 as shown in FIG. 17.

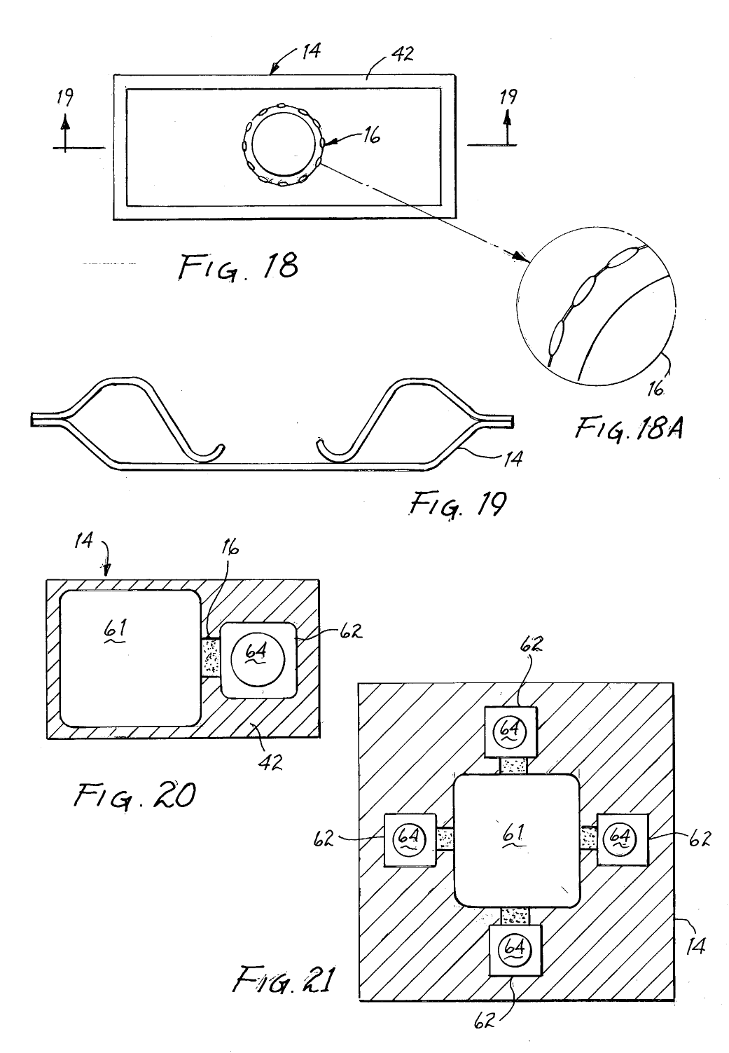

The rupturable barrier 16 may be weakened portions in the flexible pouch itself as shown in FIGS. 1C and 1D and FIGS. 18-19. This type of rupturable barrier 16 is typically used when absorption of the product into the at least one substrate layer 12 prior to reaching the target surface 18 is not of substantial concern as hereinafter described. The weakened portions of the pouch (i.e. the rupturable barrier 16) may be constructed, for example, with the same pouch material as the rest of the pouch but thinner in cross section (FIG. 1C) or with a patch of a different pouch material having a lower threshold for failure (FIG. 1D). The thin areas may also be alternated with thicker sections as shown in FIGS. 18-19 to provide added strength to the rupturable barrier 16 to substantially ensure that the rupturable barrier does not rupture during transit or handling. The rupturable barrier 16 may also include frangible seals, zippers, heat seams, tear strips, scores, perforations and the like. The rupturable barrier 16 may also be a portion of the flexible pouch that is punctured by a puncture device 44a-44d as hereinafter described and shown in FIGS. 4-7. It is to be understood that the pouch may be cut open to access the product and that any other means of rupturing a flexible container 14 known in the art may be used.

The rupturable barrier 16 may be in product communication with at least one exit channel 32. The at least one exit channel 32 may be vertically aligned with the rupturable barrier 16 and the puncture device 44a-44d. The at least one exit channel 32 extends downwardly from the flexible pouch 14 through at least a portion of the substrate layer(s) and/or apertured thermoplastic film layer(s) toward the target surface 18. In a first embodiment, the at least one exit channel 32 may be formed, for example, by die-cutting a vertical channel through the at least one substrate layer(s) and/or apertured thermoplastic film layer(s) as shown in FIGS. 1A, 2A, 3, 11 and 24. In a second embodiment, the at least one exit channel 32 comprises a tube having outwardly-extending shoulders 46 at a top end. The shoulders 46 may be affixed to the outboard bottom surface 40 of the flexible pouch as shown in FIGS. 4-6 or affixed inside the flexible pouch to the inboard bottom surface 40 thereof as shown in FIG. 7. The at least one exit channel 32 may be formed from a directional nozzle made from polyethylene or high density polyethylene plastic or the like as shown in FIGS. 4-7. The at least one exit channel 32 substantially directs the flow of product from the burst rupturable barrier 16 to the target surface 18 bypassing the at least one substrate layer and/or the at least one dri-weaver layer. The use of a surface treatment article with the at least one exit channel 32 is particularly advantageous when treating a stain because of the substantially direct application of product to the stain. The product soaks on the stain for a period of time. If the at least one substrate layer 12 is an absorbent material, the user may apply pressure to a top surface of the surface treatment article to absorb the stain and product into the absorbent material. The surface treatment article 10 may be moved to expose a new section of the absorbent substrate layer to further absorb the stain that may be repeated until the stain is removed. When completed, the stain is substantially dry with substantially little chemical residue.

As shown, for example, in FIG. 1B, a surface treatment article 10 without the at least one exit channel 32 may also be used where direct application of product to the target surface 18 may not be desired or where it is desired that the surface treatment article be saturated with the product prior to treating the target surface 18.

If the at least one exit channel 32 is used, it may include a rupture disk 48 as shown in FIG. 12. The shoulders 46 of the exit channel 32 may be extended horizontally inboard of the exit channel 32 to define the rupture disk 48. The rupture disk 48 extends across the top of the exit channel 32 with the rupturable barrier 16 substantially in the center of the rupture disk 48. When a rupture disk is used, the pouch 14 includes an outlet (not shown) die cut through the bottom surface 40 thereof. The rupture disk 48 underlies the pouch 14 and blocks the outlet until the rupturable barrier 16 bursts by the application of pressure. The rupturable barrier 16 is vertically aligned with the outlet in the pouch. When the rupturable barrier 16 bursts, the outlet is exposed allowing the product in the pouch to flow down to the target surface 18 through the exit channel 32. Although the rupture disk and the exit channel are shown as one-piece, it is to be understood that they may be separate pieces.

As shown in FIGS. 4-7, the at least one exit channel 32 and rupturable barrier 16 are also vertically aligned with the puncture device 44a-44d. The puncture device 44a of FIG. 4 comprises a puncture disk 50a with a sharpened point 52a in substantially the center of the puncture disk 54a and a plurality of bosses 56a along the circumference of the puncture disk 50a. The plurality of bosses 56a may be shorter than the sharpened point 52a. The purpose of the bosses is to create space between the puncture disk 50a and the ruptured barrier to enable the product to flow past the puncture device 44a into the at least one exit channel 32 i.e. to substantially prevent the puncture disk 50a from completely sealing the ruptured barrier as hereinafter described. A bottom surface of the puncture disk may be affixed to the inside top surface 38 of the pouch in a manner such that the sharpened point 52a of the puncture device 44a points downwardly toward the rupturable barrier 16 in the bottom surface of the pouch 40. The puncture device 44a may be affixed to the flexible pouch by ultrasonic, heat seal, hot melt glue, or the like.

The puncture device 44b of FIG. 5 comprises an extension of a free end of the at least one exit channel 32, the extension including a flexible arm 54 with the sharpened point 52b.

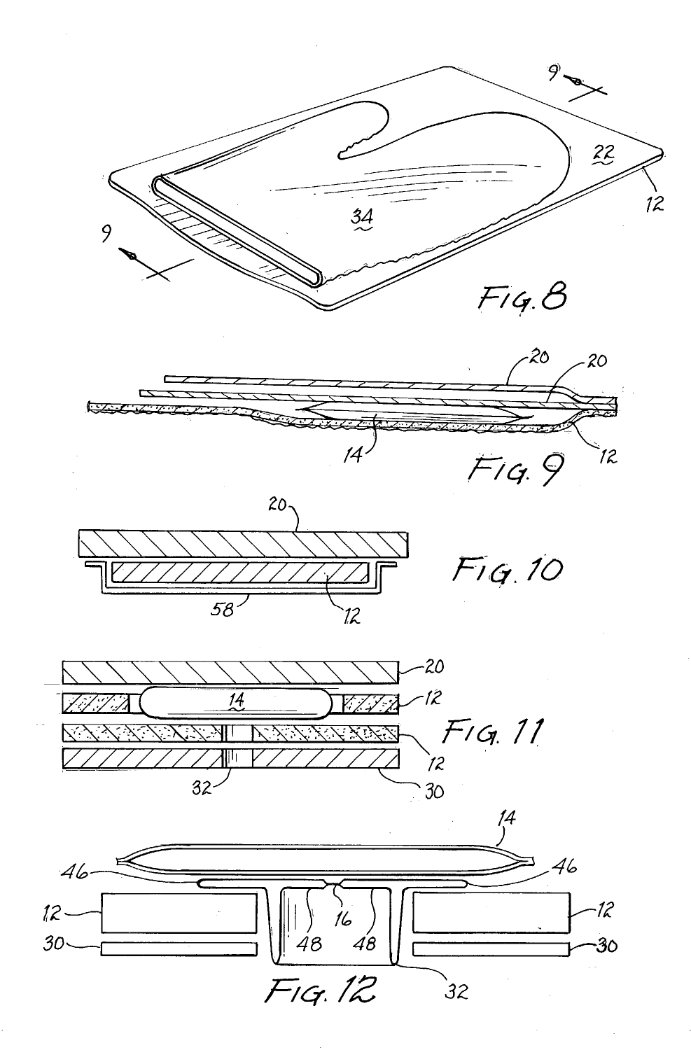

The puncture device 44c of FIG. 6 comprises a puncture disk 50c with a sharpened point 52c in substantially the center of the puncture disk and at least one opening 60 in the puncture disk 50c. The puncture disk 50c is friction fit into the at least one exit channel 32 such that the sharpened point 52c points upwardly toward the rupturable barrier 16 in the bottom surface 40 of the pouch.

The puncture device 44d of FIG. 7 comprises a puncture disk 50d with a sharpened point 52d in substantially the center of the puncture disk 50d and a plurality of bosses 56d that snap fit over a lower portion of the at least one exit channel 32 and the protruding pouch 14.

When pressure is applied to the top surface 38 of the pouch, the sharpened point 52a-52d of the puncture 44a-44d devices is driven downwardly (FIG. 4) or upwardly (FIGS. 5-7) to puncture the rupturable barrier 16 in the bottom surface of the pouch causing at least a portion of the product to be expelled from the pouch. The product flows into the exit channel 32 through the space created by the bosses (FIG. 4A and FIG. 7 or through the at least one opening in the disk (FIG. 6A). The product is then directed to the target surface 18 down the at least one exit channel 32.

In an alternative embodiment as shown in FIGS. 13-16, the pouch 14 is bottle shaped with a neck terminating in a tab 28 (See. FIG. 16). The tab 28 includes a rupturable barrier 16 in the form of a frangible seal (FIG. 17). The tab 28 may be inserted into the slot 26 (See FIG. 13A) in the top surface 22 of the substrate layer as shown in FIG. 13. Insertion of the pouch tab into the slot is typically done by the manufacturer. The pouch may be removable for spot cleaning with the contents of the pouch. Alternatively, the pouch may be further affixed to the top surface of the substrate layer by adhesive or the like. To use the surface treatment article shown in FIG. 14, the article is turned over so that the pouch 14 contacts the target surface 18 and the at least one substrate layer 12 is the contact layer for the user's hand or foot to apply pressure. Pressure may be applied to the substrate layer thus breaking the frangible seal in the tab 28 causing at least a portion of the product to be expelled from the pouch out of the tab 28 as shown in FIGS. 14 and 15 onto the substrate layer for application onto a target surface 18.

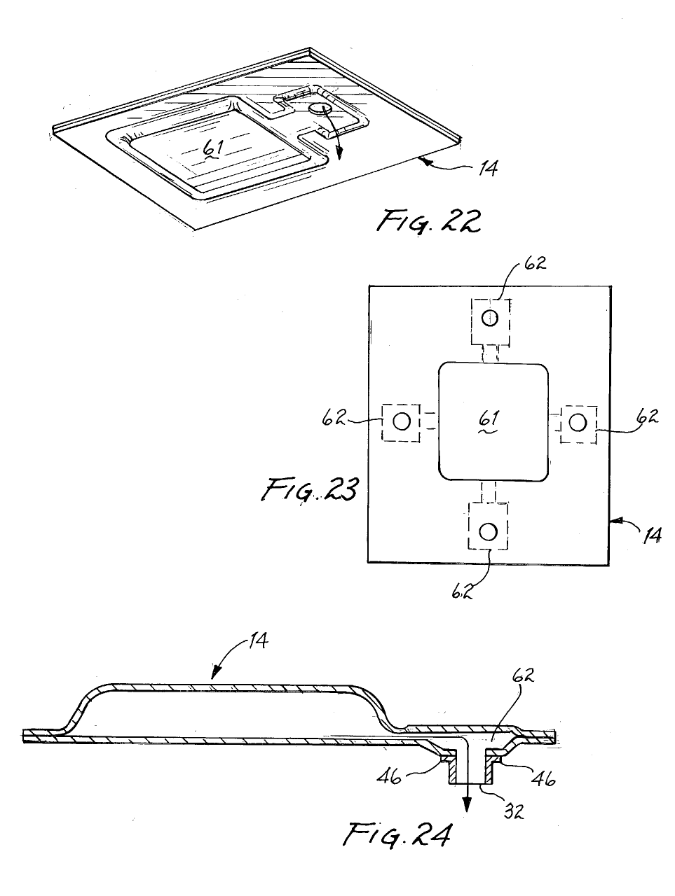

As shown in FIGS. 20-24, the flexible container 14 containing the product may include the at least one primary chamber 61 connected to the at least one secondary chamber 62 by a rupturable barrier 16 such as a frangible seal or other rupturable barrier 16 such as described above. FIGS. 20, 22, and 24 show the primary chamber 61 and one secondary chamber 62. FIGS. 21 and 23 show the primary chamber and four secondary chambers. It is to be appreciated that any number of primary and/or secondary chambers may be used. The secondary chamber(s) may be initially empty. The secondary chambers may include at least one opening 64 therein through which product is expelled when the rupturable barrier 16 between the primary chamber and the respective secondary chamber 62 is ruptured thus permitting the flow of product from the primary chamber(s) into the secondary chamber(s) and out of the secondary chamber(s) through an opening therein and onto the at least one substrate layer 12. The opening may be in product communication with at least one exit channel 32 as shown in FIG. 24. This arrangement provides for more than one point of release of the product. This is particularly advantageous when treating a large surface area.

It is to be appreciated that multiple products can be housed in adjacent flexible containers on the same surface treatment article (not shown). The flexible containers may separately contain the products prior to activation. Applying pressure to one or more of the flexible containers such as by squeezing, pressing, kneading, etc. may rupture the respective rupturable barriers seals and mix the first and second products together on the substrate layer or the target surface 18. Alternatively, the flexible containers may be ruptured sequentially. For example, a flexible container 14 containing a cleaning agent may be ruptured prior to a flexible container 14 containing air freshener. Alternatively (not shown), the flexible containers may themselves be separated by one or more additional rupturable barriers such as a frangible seal or other rupturable barrier such as described above. It is to be appreciated that any number of flexible containers may be included with a corresponding number of products.

The products in the at least one flexible container 14 include, but are not limited to, water, hand cleaners, oven cleaners, tire dressings, dash protectants, bug and tar removers, stain removers, carpet cleaners, glues, floor cleaners, leather cleaners, shoe shining creams and liquids, wood polishers, liquids, oils, waxes, emollients, lotions, glass cleaners, wood stains, saline rinses for wound care, suntan lotions, bug repellant, disinfectants, oven cleaners, antibiotics, or any other flowable product to be dispensed from the flexible container 14. “Flowable” is defined for the purposes of the present invention as a material that is in a substantially liquid state, substantially liquid state with suspended particles/granules/foods, a non-packing powder, granule or the like.

The surface treatment article 10 may be housed within an outer container 58 as shown in FIG. 10. The outer container, for example, may comprise a thermoformed container, a carton, one or more polymeric materials, metallized or laminate structures, lined paperboards, etc or other conventional outer containers.

In the method of the invention, the surface treatment article 10 is placed onto the target surface 18. The user applies pressure to the surface treatment article thereby breaking the rupturable barrier 16 of the flexible container 14 to dispel at least a portion of the product therefrom into the at least one substrate layer 12 or through at least one exit channel 32 directly onto the target surface 18. The used surface treatment article may then be discarded.

From the foregoing, it is to be appreciated that the surface treatment article of the present invention is extremely convenient and may be used to treat any surface. For example, the surface treatment article may be used in medical applications to deliver medicinal or cleaning agents to skin, to wounds, etc. Other exemplary applications including household, industrial/janitorial, and automotive cleaning, waxing, polishing, fixing, conditioning, and disinfecting, etc. The surface treatment articles may be used in manufacturing processes to clean and prepare surfaces for the next process step, for spill control (i.e. neutralizing chemicals before cleaning up), for disinfecting surfaces with a high active ingredients article, for a marking system, etc.

Although a particular embodiment of the invention has been described in detail for purposes of illustration, various modifications may be made without departing from the spirit and scope of the invention. Accordingly, the invention is not to be limited, except as by the appended claims.

I claim:

1. The surface treatment article comprising:
at least one substrate layer; and
at least one flexible container containing a product and having at least one rupturable barrier adapted to burst under an application of pressure to allow at least a portion of said product to be expelled from the at least one flexible container for use with the at least one substrate layer for treating a target surface.

2. The surface treatment article of claim 1, further comprising at least one moisture impermeable layer over the at least one flexible container to act as a barrier between a user and the product.

3. The surface treatment article of claim 2, wherein the at least one moisture impermeable layer comprises a plastic film.

4. The surface treatment article of claim 1, wherein the at least one substrate layer includes a top and a bottom surface, the bottom surface including at least one layer of an apertured thermoplastic film to contact the target surface.

5. The surface treatment article of claim 1, wherein the at least one substrate layer is selected from the group consisting of a woven fabric, knit fabric, nonwoven fabric or web, foam and paper material.

6. The surface treatment article of claim 1, wherein the at least one flexible container is a flexible pouch including a permanent seal in addition to the at least one rupturable barrier.

7. The surface treatment article of claim 6, wherein the flexible pouch has a top surface and a bottom surface, the bottom surface including the at least one rupturable barrier.

8. The surface treatment article of claim 7, wherein the surface treatment article includes at least one exit channel vertically aligned with the at least one rupturable barrier and extending downwardly therefrom to deliver product expelled from the flexible pouch directly onto the target surface.

9. The surface treatment article of claim 7, wherein the at least one rupturable barrier comprises at least one weakened portion of the flexible pouch.

10. The surface treatment article of claim 9, wherein the at least one weakened portion of the flexible pouch includes alternating thick and thin sections.

11. The surface treatment article of claim 6, wherein the at least one substrate layer includes a top and a bottom surface, the top surface including a slot to receive a tab of the flexible pouch, whereby the tab includes the at least one rupturable barrier.

12. The surface treatment article of claim 8, wherein the at least one exit channel comprises a tube affixed to the bottom surface of the flexible pouch.

13. The surface treatment article of claim 12, wherein a puncture device including a sharpened point vertically aligned with the at least one rupturable barrier punctures the at least one rupturable barrier upon the application of pressure causing the expulsion of product from the flexible pouch into the at least one exit channel.

14. The surface treatment article of claim 2, wherein the at least one moisture impermeable layer takes the form of a mitt.

15. The surface treatment article of claim 12, wherein the at least one exit channel further includes a rupture disk underlying the flexible pouch.

16. The surface treatment article of claim 6, wherein the flexible pouch includes a primary chamber containing the product connected to at least one secondary chamber by the at least one rupturable barrier, the at least one secondary chamber including an opening for expulsion of the at least a portion of the product from the flexible pouch when the at least one rupturable barrier between the primary chamber and the at least one secondary chamber bursts.

17. The surface treatment article of claim 2, further comprising a useful layer for finishing the target surface after delivery of the at least a portion of the product thereto, the useful layer over the at least one moisture impermeable layer.

18. A multi-layered surface treatment article, comprising:
at least one dry upper layer of material;
at least one wet lower layer of material for contacting a target surface and receiving at least a portion of a product from at least one flexible container positioned on or about the at least one wet lower layer of material, the flexible container having at least one rupturable barrier that bursts under an application of pressure; and
at least one substantially moisture impermeable layer between the at least one wet layer of material and the at least one dry layer of material.

19. The multi-layered surface treatment article of claim 18, wherein the at least one wet lower layer comprises a substrate selected from the group consisting of a woven fabric, knit fabric, nonwoven fabric or web, foam and paper material.

20. The multi-layered surface treatment article of claim 19, wherein a bottom surface of the substrate is covered by at least one layer of an apertured thermoplastic film.

21. The multi-layered surface treatment article of claim 18, wherein the at least one dry upper layer comprises a mitt.

22. A method for delivering a product to a target surface, comprising:
providing a product in at least one flexible container connected to at least one substrate layer;
placing the at least one substrate layer on the target surface; and
applying pressure to the at least one flexible container to burst a rupturable barrier of the at least one flexible container to deliver the product to the target surface for treatment thereof with the at least one substrate layer.
